(19) United States
(12) Patent Application Publication
(10) Pub. No.: US 2015/0337889 A1
(43) Pub. Date: Nov. 26, 2015

(54) FOOD COMMINUTION DEVICE

(71) Applicant: GENIUS GMBH, Limburg (DE)

(72) Inventor: Cedomir REPAC, Brechen (DE)

(21) Appl. No.: 14/654,557

(22) PCT Filed: Dec. 20, 2013
(86) PCT No.: PCT/EP2013/077789

§ 371 Date: Jun. 22, 2015

(30) Foreign Application Priority Data
Dec. 28, 2012 (DE) 10 2012 224 518.9

(51) Int. Cl. F16C 11/04; A47J 43/25; B26D 7/06; B26D 1/30; B26D 3/18

(52) U.S. Cl. CPC F16C 11/04; B26D 1/30; B26D 3/185; B26D 7/0608; A47J 43/25; B26D 2007/0018

(57) ABSTRACT

The invention relates to a joint, in which a first joint part and a second joint part are connected so as to be pivotable relative to one another, having a drive device, in particular a spring drive, for assisting or effecting the pivoting movement. The joint is characterized in that the drive device is selectively activatable or deactivatable and/or in that the assistance force of the drive device is adjustable. The invention also relates in particular to a food comminution device having a joint of said type.

### CROSS-REFERENCE TO RELATED APPLICATIONS

The present application is the U.S. national phase of International Application No. PCT/EP2013/077789 filed Dec. 20, 2013, which claims priority of German Application No. 10 2012 224 518.9 filed Dec. 28, 2012, the entirety of which is incorporated herein by reference.

### FIELD OF THE INVENTION

The invention relates to a joint, in which a first joint part and a second joint part are connected so as to be pivotable relative to one another, having a drive device, in particular a spring drive, for assisting or effecting the pivoting movement, wherein the drive device is selectively activatable or deactivatable and/or wherein the assistance force of the drive device is adjustable.

The invention also relates to a food comminution device having a joint of said type.

### BACKGROUND OF THE INVENTION

Joints of the type mentioned in the introduction are known for a wide variety of applications, in particular for doors, items of furniture or kitchen appliances.

For example, food comminution devices exist which are in the form of handheld implements, configured in the manner of tongs, for the comminution of relatively small food items such as mushrooms, for example, having an actuation part and having a base part which has a cutting part, wherein the base part and the actuation part are articulatedly connected such that, for pushing through food items for comminution, the actuation part can be pivoted from a loading position toward the cutting part into a closed position and subsequently from the closed position into the loading position again.

For example, DE 102 42 651 A1 has described a cutting appliance for foodstuffs or similar items for cutting, having a cutting part on which there are fitted multiple substantially parallel blades which have cutting edges, said cutting edges forming a cutting surface for the items for cutting in order to cut said items into strips or slices or similar. An actuation part in the form of a plunger has a base surface which can be moved toward and away from the cutting surface, with the items for cutting situated in between. The base surface has groove-like or slot-like receptacles which substantially correspond to the blades and which have interposed webs. The base surface acts on the items for cutting and moves these toward the cutting surface and through between the blades. It is provided that the cutting part and the plunger are arranged in the region of the free end of a respective arm of the tongs, wherein the arms of the tongs are pivotably connected in the region of the other, free end by means of a pivot bearing, and wherein the arms of the tongs are preloaded into an open position by means of a spring.

A similar appliance with a special cutting blade arrangement is known from DE 20 2007 018 922 U1.

The appliances mentioned above are appliances which are held in one hand, similarly to a pair of tongs, and in the case of which the comminution process is performed by closing the hand in which the comminution device is held, with two arms of the tongs being pushed together as a result.

As described below, appliances also exist which are of completely different design, and which are not held in the hand but which are placed on a worktop. These appliances normally have a container for the items for comminution. The only common aspect that these appliances share with the appliances mentioned above is the comminution principle, specifically the fact that the items for comminution are pushed through a cutting device.

For example, DE 10 2009 023 167 A1 discloses a device for cutting foodstuffs, such as fruit and vegetables, having a cutting part which has multiple cutting edges, and having an actuation part, said cutting part and actuation part being mounted so as to be pivotable relative to one another. To cut the items for cutting, the actuation part is pushed toward the cutting part, wherein the actuation part has a plunger which pushes the items for cutting through the cutting part, wherein the cutting edges protrude into corresponding depressions of the plunger. The cutting part has a cutting frame in which cutting blades are held. The device furthermore has a cover part for mounting on a receiving container for the cut items for cutting, wherein the cover part has an opening which forms a passage for the cut items for cutting.

Other devices for placing on a worktop are known for example from DE 20 2011 050 041 U1 and from DE 21 2005 000 048 U1.

The known devices which are placed on a worktop do not have a drive device, such that both the pivoting movement from the loading position into the closed position and also the pivoting movement from the closed position into the loading position must be performed by the user.

In the case of the handheld appliances described in the introduction, it may be the case, depending on the type of items for comminution, that the spring force is not adequate to move the arms of the tongs back into the initial position after a comminution process. This may be the case for example because parts of the items pass laterally between the blades and the walls of the slots of the pressing plunger, and thus jam the mechanism. On the other hand, the provision of a very strong spring has the disadvantage that the user must impart not only the force for pushing the items for comminution through the cutting part but also the force for placing the spring under stress, such that the comminution of certain foodstuffs could become impossible if the manual force that the user is capable of imparting is not high enough.

EP 1 308 118 discloses a joint arrangement which is provided in particular for a wall-mounted sanitary appliance. The device has a base part which is mounted on a wall, and a pivoting part which is rotatably mounted on the base part by means of a bearing spindle and which is, in particular, pivotable between a vertical and a horizontal position. Between the base part and the pivoting part there is positioned a spring which acts as a fall brake, counter to the restoring force of which the pivoting part can be moved into its horizontal position. The return movement of the pivoting part into its vertical initial position is assisted by the spring owing to its stress. The spring force is adjustable but not activatable or deactivatable, and the individual structural components are not detachable from one another, or are only partially detachable by means of tools.

Food comminution devices from the prior art which comprise joints or joint-like components will be discussed below.

DE 75 37 140 U discloses a cutting device for potatoes, apples or the like. The device comprises a static blade with multiple cutting blades, and a voluminous plunger that interacts therewith. The plunger is fastened to an even more voluminous housing. The entire housing is mounted in pivotable fashion by means of a shaft. Situated spatially entirely separately therefrom there is a motor which drives a crank disc. The crank disc is articulatedly connected to the housing by way of a long lever, in order thereby to effect a pivoting movement of the housing and of the plunger.

DE 20 2010 016 538 U1 has disclosed a device for cutting foodstuffs such as fruit and vegetables. The device comprises a cutting part, which has multiple cutting blades, and an actuation part, said cutting part and actuation part being mounted so as to be pivotable relative to one another by means of a pivot bearing, wherein, in order to cut the items for cutting, the actuation part is pushed toward the cutting part. One embodiment comprises a cover part for mounting on a receiving container for the cut items, wherein the cover part comprises an opening which forms a passage for the cut items. The device is exclusively manually operated.

US 2009/0158903 A1 discloses a device for the comminution of foodstuffs. The device has a manually operated drive device. The drive device comprises two gearwheels which transmit the drive power imparted by the user to the comminution element of the device, wherein the drive device is not activatable or deactivatable.

Even in the case of other uses of joints of the type mentioned in the introduction, similar problems can be encountered.

### SUMMARY OF THE INVENTION

It is the object of the present invention to specify a joint which can be individually adapted to different requirements.

The object is achieved by means of a joint which is characterized in that, when the drive device is deactivated, the first joint part is freely pivotable relative to the second joint part, and/or in that at least in a particular pivoting position, the first joint part is detachable from the second joint part, in particular exclusively by virtue of the first joint part and second joint part being pulled apart.

The joint according to the invention has the advantage that the assistance by the drive device can be used or adjusted in a situation-dependent manner without the need for exchanging the entire joint.

A deactivation is preferably realized by virtue of the first joint part being freely pivotable relative to the second joint part when the drive device is deactivated.

The joint according to the invention has the advantage that the articulated connection is configured such that, at least in a particular pivoting position, the joint parts are detachable from one another, in particular exclusively by virtue of the joint parts being pulled apart.

In a very particularly advantageous embodiment, it may advantageously be provided that multiple, in particular precisely two, drive devices and multiple, in particular precisely two, coupling devices are provided, and in that each of the drive devices is selectively activatable or deactivatable in each case by means of one coupling device. In particular, it may advantageously be provided that the multiple drive devices are activatable or deactivatable independently of one another.

Such an embodiment has the very special advantage that assistance or generation of the pivoting movement can be fully eliminated through deactivation of all drive devices, that maximum assistance or generation of the pivoting movement can be realized through activation of all drive devices, and that furthermore, that an intermediate setting can be realized through activation of only some of the drive devices.

In a very particularly advantageous embodiment, the joint has two sub-joints which are arranged mirror-symmetrically with respect to one another and which have coaxial pivot axes and which serve for the articulated coupling of the actuation part to the base part. In this case, it may be provided in particular that each of the sub-joints has a drive device, or that a dedicated drive device is installed at each of the sub-joints. It is preferably also the case that the drive devices are constructed and arranged mirror-symmetrically relative to one another.

In a particular embodiment, the drive device is selectively activatable or deactivatable by means of a switchable coupling device. Special possibilities for the design of a coupling device of said type are described by way of example further below.

In particular, it may be provided that mechanical coupling of the drive device to the first joint part and/or to the second joint part can be effected, for example through the production of a positively locking connection or a frictionally locking connection, by means of the coupling device.

In a particular embodiment, the coupling device has a coupling element which can be transferred into either a coupling position or a decoupling position, wherein mechanical, in particular positively locking and/or rotationally conjoint, coupling of a spring of the drive device to the first joint part or to the second joint part is effected by the coupling element in the coupling position, and the mechanical coupling is eliminated in the decoupling position. In particular, it may be provided that one end and/or one leg of the spring is fixedly connected to the first joint part, whereas the other end and/or the other leg of the spring can be selectively coupled to the second joint part by means of the coupling element. It is self-evidently also conversely possible that one end and/or one leg of the spring is fixedly connected to the second joint part, whereas the other end and/or the other leg of the spring can be selectively coupled to the first joint part by means of the coupling element.

In particular, it may advantageously be provided that the coupling element, when in the coupling position, engages into a recess of the first joint part or of the second joint part and, in the decoupling position, is arranged outside the recess. The recess may for example be arranged in a joint head or in a joint head receptacle.

In particular if a torque imparted by the drive unit is to be transmitted so as to assist or effect the pivoting movement, it may advantageously be provided that the coupling element, when in the coupling position, is arranged so as to be non-rotatable relative to the recess, into which it engages, of the first joint part or of the second joint part. This may be achieved for example in that the coupling element is of non-circular, in particular polygonal, form in cross section and, in the coupling position, engages into a corresponding non-circular, in particular polygonal, recess of the first joint part or of the second joint part.

In a particular embodiment, the coupling element is in the form of an in particular linearly displaceable slide. In this case, it may be provided in particular that said slide, in order to effect the coupling position, can be slid, in particular in positively locking and/or non-rotatable fashion, into a recess of the first joint part or of the second joint part, and in order to effect the decoupling position, is pulled out of the recess of the first joint part or of the second joint part.

In an advantageous embodiment, which makes it possible in particular for the drive device or the drive devices to be accommodated in a particularly space-saving manner and in an unobtrusive position, it is provided that the joint is formed, in particular as a hinged joint, with a joint head and a joint head receptacle.

In a particular embodiment, the recess into which the coupling element can engage is arranged in one part of the articulated connection, in particular in a joint head or in a joint head receptacle.

In the case of such an embodiment in particular, it may for example be provided that the coupling element is arranged, in particular movably, in a joint head or in a joint head receptacle, and/or that the coupling element forms a joint head.

In a particularly reliable and compact embodiment, the coupling element, which is for example in the form of a slide, is arranged on the pivot axis of the joint. In particular, it may be provided here that the coupling element is guided so as to be displaceable along the pivot axis of the joint.

In the particular embodiment, the first joint part has a joint head and the second joint part has a joint head receptacle for the joint head. It may alternatively also be provided that the second joint part has a joint head and the first joint part has a joint head receptacle for the joint head.

In a particular embodiment, one of the joint parts has a joint head receptacle into which a joint head, which is for example in the form of a peg, of the other joint part can be received for the purpose of forming the articulated connection. Furthermore, in this embodiment, the joint head receptacle preferably has a guide for a coupling element which is in the form of a slide and which can be displaced along the pivot axis of the articulated connection either into a coupling position or into a decoupling position. In the coupling position, a free end of the slide engages rotationally fixedly into a recess of the joint head and thus couples a spring which is fixed to the actuation part, in particular a spiral spring or helical spring or a leg spring, to the base part. As one of the joint parts pivots relative to the other joint part, the spring is placed under stress, and energy for the return pivoting movement is stored.

Here, it may be provided in particular that the spring is at least partially in the form of a spiral spring which concentrically surrounds the pivot axis. In particular, it may also be provided that the outer end of the spiral spring is fixed to one of the joint parts, whereas the inner end of the spiral spring is arranged in a longitudinal slot of the coupling element, which is in the form of a slide. In this way, it is made possible for the slide to be displaced along the pivot axis without bending the spiral spring.

It is also possible for the spring to be in the form of a helical spring, wherein one end of the helical spring is arranged in linearly displaceable fashion in a longitudinal slot of the coupling element which is in the form of a slide, whereas the other end is fixed to one of the joint parts.

To effect rotationally rigid coupling of the coupling element to the base part, provision may be made, as already discussed, for the coupling element to be of non-circular form in cross section at its free end, such that it cannot rotate in the correspondingly formed receptacle.

A further embodiment has the very particular advantage that the joint parts can, for example for a cleaning or maintenance process, be separated from one another easily and preferably without the aid of a tool. A further advantage of such an embodiment lies in the fact that one of the joint parts can also be replaced with another joint part if required. In this way, different components which each have a corresponding joint part can be easily articulately connected to one another and separated from one another again.

Such tool-free separability of the joint parts may for example be realized by virtue of the joint head receptacle having a radial opening through which the joint head can be removed from or inserted into the joint head receptacle in a radial direction.

In a very particularly advantageous embodiment, at least in a particular pivoting position, the joint parts are detachable from one another, in particular exclusively by virtue of the joint parts being pulled apart, regardless of whether the drive device is activated or deactivated and/or regardless of whether the coupling element is situated in the coupling position or in the decoupling position.

This may be achieved for example by virtue of the receptacle having an additional, in particular radially oriented opening through which the coupling element can be removed from the receptacle preferably in a radial direction, that is to say perpendicular to the pivot axis of the joint. In the case of such a design, it is accordingly not necessary for the coupling element to initially be transferred into the decoupling position and thus removed from the receptacle in order to permit a detachment of the joint parts from one another. Rather, as already mentioned, the coupling element can be removed from the receptacle through the additional opening.

As already mentioned, it may advantageously be provided that the activated drive device is supported, on the one hand, on the first joint part and, on the other hand, on the second joint part, and/or that the activated drive device acts and/or is arranged between the first joint part and the second joint part.

As already mentioned, the joint may for example be in the form of a hinged joint.

In particular, it may advantageously be provided that the first joint part, on the one hand, has at least one joint head, and the second joint part, on the other hand, has a corresponding joint head receptacle for the joint head, or that conversely, the second joint part, on the one hand, has at least one joint head, and the first joint part, on the other hand, has a corresponding joint head receptacle for the joint head.

In the case of such a device, it may advantageously be provided that the activated drive device is supported, at the one hand, on the joint head and, on the other hand, on the joint head receptacle.

As has likewise already been mentioned, the drive device may have at least one spring, in particular a spiral spring or a helical spring or a leg spring. The drive device may alternatively or additionally also have a gas pressure spring. The drive device may also be in the form of an electromotive drive device.

In a particular embodiment, the drive device has at least one spring which is placed under stress during the pivoting of the first joint part relative to the second joint part and which relaxes so as to assist the return pivoting movement.

What is very particularly advantageous is a food comminution device having a joint according to the invention.

Such a food comminution device has the advantage that it can be adjusted, in accordance with the type of items for comminution, such that a fast and efficient comminution process is always made possible.

A food comminution device of said type may for example be constructed such that the first joint part is part of a base part or is fixed to a base part, and such that the second joint part is part of an actuation part or is fixed to an actuation part. In particular, it may additionally be provided that the base part has a cutting part with at least one cutting blade, and that the base part and the actuation part are articulatedly connected by means of the joint such that, for pushing through foodstuffs to be comminuted, the actuation part can be pivoted from a loading position toward the cutting part into a closed position and subsequently from the closed position back into the loading position.

In a particularly advantageous embodiment of a food comminution device of said type, the drive device is designed and arranged so as to assist or effect the pivoting movement from the closed position into the loading position. It may alternatively or additionally also be provided that the drive device is designed and arranged so as to assist or effect the pivoting movement from the loading position into the closed position.

For example, in the case of a food comminution device in which the drive device has at least one spring which is placed under stress during the pivoting of the actuation part from the loading position into the closed position and which relaxes so as to assist the pivoting movement of the actuation part from the closed position into the loading position, a deactivation of the drive device may be realized if particularly hard foods are to be comminuted, for which purpose the user requires their full force in any case. This prevents a situation in which the user must additionally impart energy for placing the spring under stress during the pivoting of the actuation part from the loading position into the closed position.

By contrast, for the comminution of foodstuffs which can be pushed through the cutting part by means of the actuation part with little expenditure of force, the drive may be activated; for example in order to assist or automatically effect the pivoting of the actuation part from the closed position into the loading position.

In the case of a food comminution device in which the assistance force of the drive device is adjustable, it is advantageously possible, for example in a manner dependent on the cuttability of the foodstuff, for an intermediate setting between full deactivation and full activation to be selected.

As already mentioned, it is advantageously possible for a spring to be provided which is placed under stress during the pivoting of the actuation part from the loading position into the closed position and which relaxes so as to assist the pivoting movement of the actuation part from the closed position into the loading position. It is alternatively also possible for the drive device to have at least one spring which is placed under stress during the pivoting of the actuation part from the closed position into the loading position and which relaxes so as to assist the pivoting movement of the actuation part from the loading position into the closed position. In a particular embodiment, switching between the two abovementioned operating modes is possible.

The food comminution device may in particular be designed to be placed on a worktop for a comminution process. For example, the food comminution device may have a stand, for example with supporting feet, for placing on a worktop. In particular, a container for collecting the comminuted foodstuff may also be designed, and function, as a stand.

In a particular embodiment, the base part is in the form of a container for the comminuted foodstuff. Furthermore, a container of said type may also be in the form of a stand for enabling the food comminution device to be placed on a worktop.

However, regardless of whether or not the base part is also in the form of a container, it may advantageously be provided that the base part is additionally in the form of a stand for enabling the food comminution device to be placed on a worktop or has a stand for enabling the food comminution device to be placed on a worktop.

What is very particularly advantageous is a kitchen appliance which has a container for collecting the comminuted items and a food comminution device according to the invention which is designed as a cover for the container. In this case, it may advantageously be provided in particular that the food comminution device in the form of a cover can be mounted on the container so as to completely cover the container opening. In particular, it may additionally be provided that, for a comminution process, the food comminution device can be fixed temporarily to the container edge, for example by way of a screw connection or by way of a detent connection.

It is advantageously possible for the kitchen appliance to be designed to be placed on a worktop for a comminution process.

It may for example be provided that the container is in the form of a stand for enabling the food comminution device to be placed on a worktop. For example, supporting feet, in particular non-slip supporting feet composed of rubber or some other elastic material, may be arranged on the outer side of the base of the container.

### BRIEF DESCRIPTION OF THE DRAWING VIEWS

The subject matter of the invention is schematically illustrated in the drawing and will be described below on the basis of the figures, with a food comminution device being used as an example, wherein identical elements or elements of identical action are normally denoted by the same reference signs. In the drawing:

FIG. 1 shows an exemplary embodiment of a food comminution device having a joint according to the invention in a perspective view,

FIG. 2 shows a detail view of a joint head,

FIG. 3 shows a detail view of the joint head receptacles and of the drive devices,

FIG. 4 shows two diagrammatic illustrations which illustrate the activation and deactivation of a drive device,

FIG. 5 shows a detail view of the joints and of the drive devices,

FIG. 6 shows the actuation part with the drive device activated and deactivated, and

FIG. 7 shows detail views of the joints and of the drive devices in the activated state and in the deactivated state.

### DETAILED DESCRIPTION OF THE INVENTION

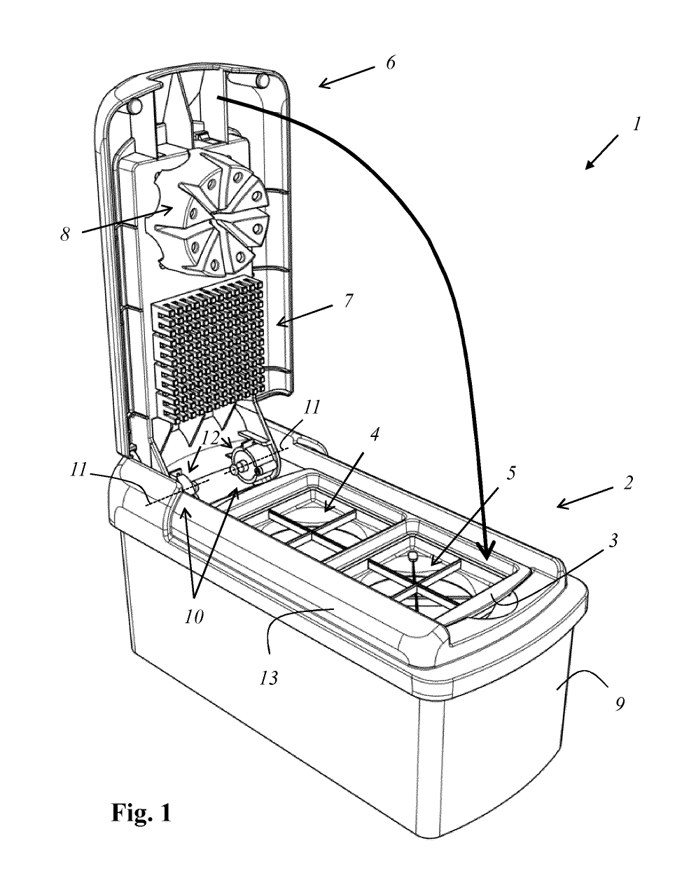

FIG. 1 shows an exemplary embodiment of a food comminution device having a joint according to the invention.

The food comminution device has a base part 2 which forms a first joint part. Furthermore, the food comminution device has an actuation part 6 which forms a second joint part.

The base part 2 has a receptacle for an exchangeable cutting part 3. In the exemplary embodiment illustrated, the cutting part 3 comprises a first cutting region 4 and a second cutting region 5, wherein the cutting regions 4, 5 each have different cutting blade arrangements.

The food comminution device 1 furthermore has an actuation part 6 which is articulatedly connected to the base part 2 such that, for pushing through foodstuffs for comminution, said actuation part can be pivoted from the illustrated loading position, in which items for comminution can be placed onto the cutting part 3, toward the cutting part 3 into a closed position (not illustrated), as indicated by the curved arrow in the figure.

The actuation part 6 has a first pressing plunger 7 and a second pressing plunger 8. The first pressing plunger 7 serves for pushing a foodstuff that has been placed onto the first cutting region 4 of the cutting part 3 through the first cutting region 4, wherein the foodstuff is cut into pieces by the cutting blades of the first cutting region 4. The second pressing plunger 8 serves for pushing a foodstuff that has been placed onto the second cutting region 5 of the cutting part 3 through the second cutting region 5, wherein the foodstuff is cut into pieces by the cutting blades of the second cutting region 5.

After being cut into pieces, the foodstuff falls into a container 9, which simultaneously serves as a stand for enabling the food comminution device 1 to be placed on a worktop (not illustrated). The food comminution device 1 is in the form of a cover which can be mounted onto the container 9 with detent action and so as to completely cover the container opening. After all of the foodstuff for processing has been pushed through the cutting part 3, the food comminution device 1 can be removed from the container 9, for example in order for the container 9 to be emptied.

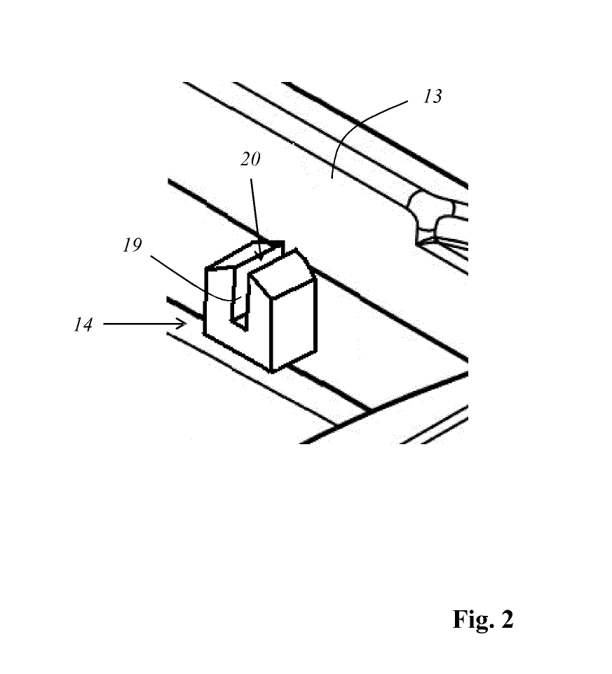

The base part 2 has a frame 13 which provides the receptacle for the cutting part 3. Furthermore, the base part 2 has two joint heads (illustrated in detail in FIG. 2) which, in interaction with the joint receptacles of the actuation part 6, permit an articulated coupling of the actuation part 6.

In the exemplary embodiment illustrated, the articulated connection of the actuation part 6 to the base part 2 is formed by two joints 10 which are of mirror-symmetrical construction and which are arranged mirror-symmetrically with respect to one another. The joints 10 are in the form of hinged joints with mutually coaxial pivot axes 11, and will be described in more detail below.

In the region of each of the joints 10 there is arranged in each case one drive device 12 for assisting or effecting the pivoting movement from the closed position into the loading position, which drive devices will likewise be described in more detail below.

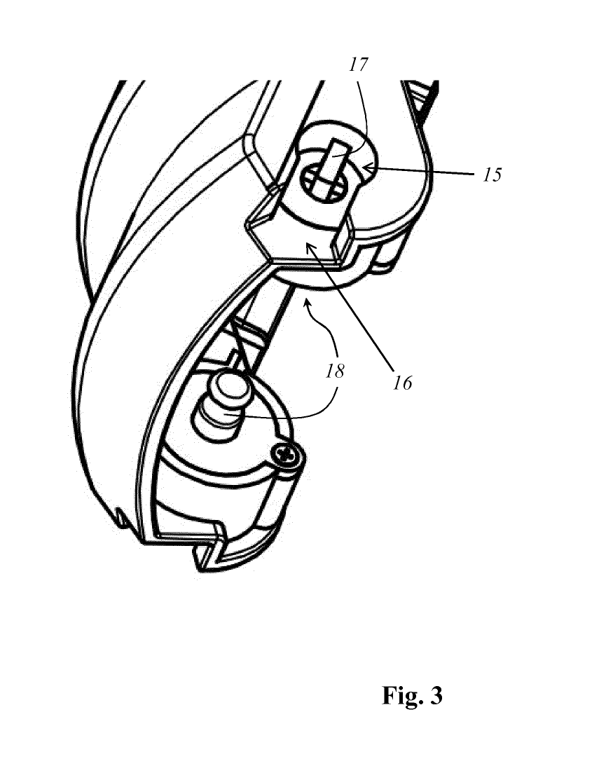

FIG. 2 shows a detail view of one of the joint heads 14 arranged on the inner side of the frame 13. The joint head 14 is substantially in the form of a peg which projects inward from the frame 13 and which has parallel walls such that a joint head receptacle 15 of the actuation part 6, as can be seen in FIG. 3, can be pushed on. For this purpose, the joint head receptacles 15 each have a radial opening 16, which radial openings enable the actuation part 6 to be pushed onto the joint heads 14 in the loading position. The width of the joint heads 14 is selected specifically such that they fit through the radial openings 16 of the joint head receptacles 15 but they can no longer exit the joint head receptacles 15 when the actuation part 6 has been pivoted from the loading position into a different pivoting position. In this way, it is ensured that the actuation part 6 does not inadvertently become detached during the comminution process.

As will be presented in detail below, an activation of the drive device 12 is realized in each case by virtue of the free end 17 of a slide 18 being slid rotationally fixedly into a recess 19 of the joint head 14. A co-rotation of the slide 18 in the coupled position is prevented by virtue of the free end 17 of the slide 18 and the recess 19 being of non-circular form, in the present example cuboidal. For the deactivation of the drive device 12, the slide 18 is pulled out of the recess 19 again.

To enable the actuation part 6 to be detached from the base part 2 in the loading position even when the slide 18 is in the coupled position, the recess and 19 of the joint heads 14 likewise have radial openings 20 which make it possible for the free ends 17 of the slides 18 to be pulled out of the recesses 19 perpendicularly to the pivot axes 11. By means of this configuration, it is advantageously achieved that the actuation part 6 can be detached from the base part 2 regardless of the position of the slides 18. Accordingly, the user is not forced to deactivate the drive devices before being able to detach the actuation part 6 from the base part 2, for example for a cleaning process.

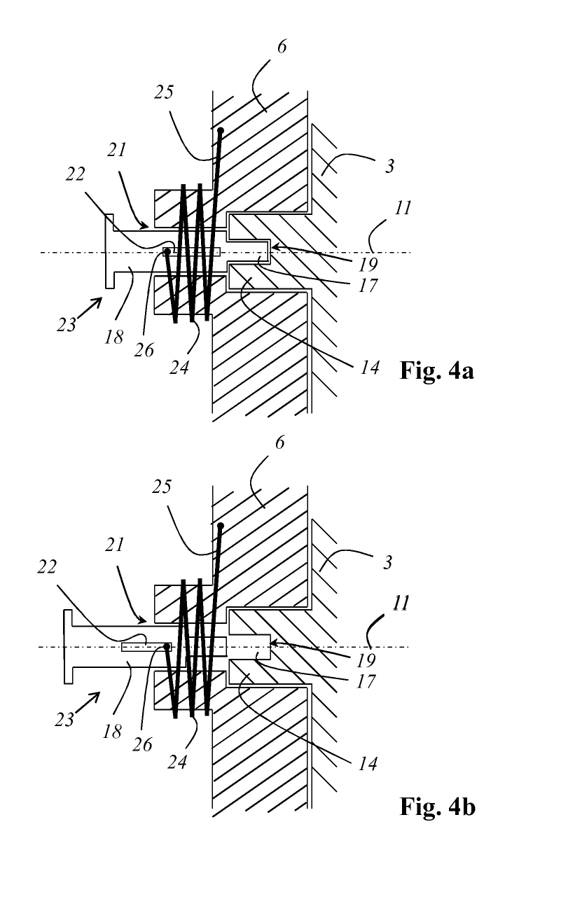

FIGS. 4a and 4b each show a joint 10 which is formed from a joint head receptacle 15 of an actuation part 6 and a joint head 14 of a base part 2, and illustrate the principle of the activation and deactivation of the drive device, which is in the form of a helical spring 24.

The joint 10 makes it possible for the actuation part 6 to be pivoted relative to the base part 2 about a pivot axis 11. In the actuation part 6 there is provided a linear guide 21 in which a coupling element 23, which is in the form of a slide 18, is guided in linearly displaceable fashion along the pivot axis 11.

The helical spring 24 concentrically surrounds the pivot axis 11, the linear guide 21 and the slide 18. A first end 25 of the helical spring 24 is in the form of a leg, and is fixed to the actuation part 6. The other end 26 of the helical spring 24 is bent at an angle and is guided in linearly displaceable fashion in a longitudinal slot 22 of the slide 18.

The free end 17 of the slide 18 is of non-circular, specifically cuboidal, form and, in the coupling position as shown in FIG. 4a, engages in positively locking fashion into a cuboidal recess 19 of the joint head 15. In said coupling position, the helical spring is placed under stress when the actuation part 6 is pivoted relative to the base part 2, for example during the movement from the loading position into the closed position. During the opposite pivoting movement, the helical spring 24 relaxes and thus effects or assists the opposite pivoting movement, for example from the closed position into the loading position.

To deactivate the drive device, the free end 17 of the slide 18 is pulled out of the recess 19. This is illustrated in FIG. 4b. In this decoupled position, the actuation part 6 can be pivoted relative to the base part 2 without the helical spring 24 being placed under stress. Rather, in this decoupled position, the coupling element 23 can co-rotate freely with the actuation part 6.

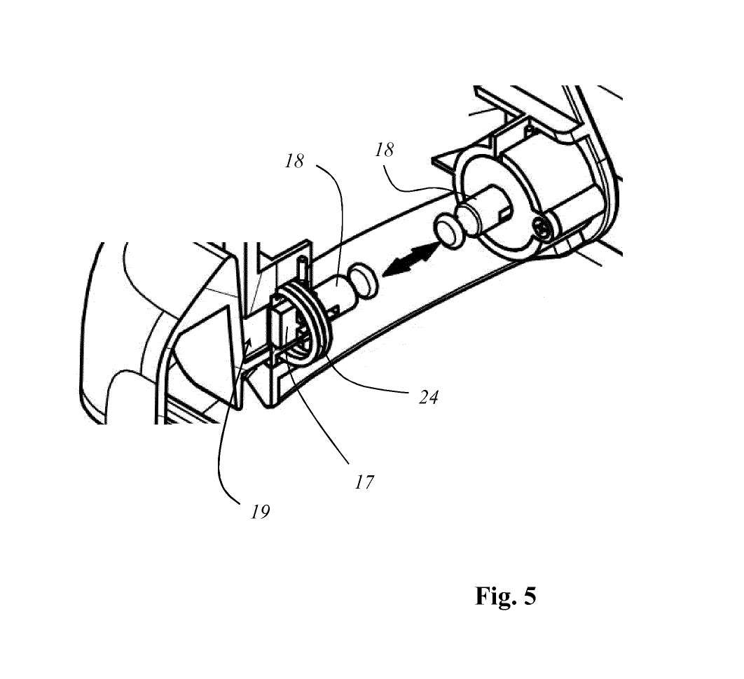

FIG. 5 shows, in a perspective illustration, the principle of the activation and deactivation of the drive device 12 which has the helical spring 24. It can be clearly seen that the left-hand drive device is deactivated because the free end 17 of the slide 18 has been pulled out of the recess 19.

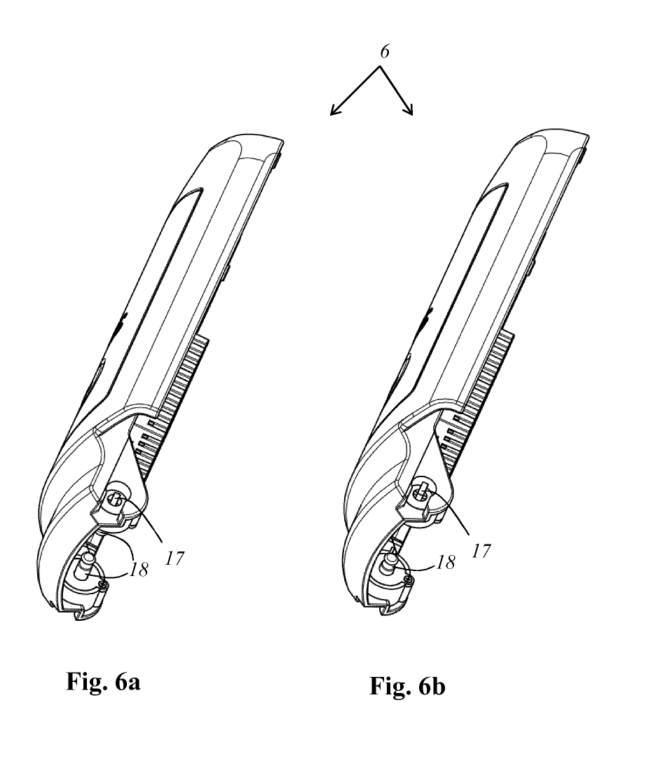

FIGS. 6a and 6b each show an actuation part 6, and illustrate the positions of the free ends 17 of the slides 18. In the case of the actuation part 6 illustrated in FIG. 6a, the free end 17 is situated in a retracted position in which it does not engage into a recess of the base part 2. In this position, the drive device is deactivated.

In the case of the actuation part 6 illustrated in FIG. 6b, the free end 17 is situated in an advanced position in which it engages into a recess of the base part 2. In this position, the drive device is activated.

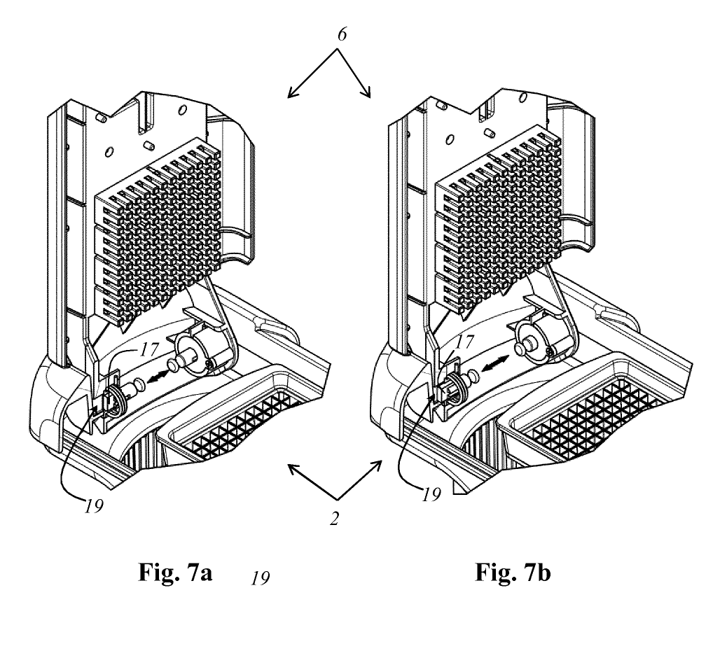

In the setting illustrated in FIG. 7a, the drive device of the left-hand joint is deactivated, because the free end 17 of the slide 18 is not engaged into the corresponding recess 19 of the actuation part 6.

In the setting illustrated in FIG. 7b, the drive device of the left-hand joint is activated, because the free end 17 of the slide 18 is engaged into the corresponding recess 19 of the actuation part 6.

### LIST OF REFERENCE NUMERALS

1 Food comminution device
2 Base part
3 Cutting part
4 First cutting region
5 Second cutting region
6 Actuation part
7 First pressing plunger
8 Second pressing plunger
9 Container
10 Joints
11 Pivot axes
12 Drive devices
13 Frame
14 Joint heads
15 Joint head receptacles
16 Radial openings in the joint head receptacles
17 Free end
18 Slide
19 Recess
20 Radial openings in the joint heads
21 Linear guide
22 Longitudinal slot
23 Coupling element
24 Helical spring
25 First end of the helical spring
26 Other end of the helical spring

1. Joint, in which a first joint part and a second joint part are connected so as to be pivotable relative to one another, having a drive device, in particular a spring drive, for assisting or effecting the pivoting movement, wherein the drive device is selectively activatable or deactivatable and/or the assistance force of the drive device is adjustable, characterized in that
a. when the drive device is deactivated, the first joint part is freely pivotable relative to the second joint part, and/or in that
b. at least in a particular pivoting position, the first joint part is detachable from the second joint part, in particular exclusively by virtue of the first joint part and second joint part being pulled apart.

2. Joint according to claim 1, characterized in that the drive device is selectively activatable or deactivatable by means of a switchable coupling device.

3. Joint according to claim 1, characterized in that multiple, in particular precisely two, drive devices and multiple, in particular precisely two, coupling devices are provided, and in that each of the drive devices is selectively activatable or deactivatable in each case by means of one coupling device.

4. Joint according to claim 1, characterized in that multiple, in particular precisely two, drive devices are provided, which are activatable or deactivatable independently of one another.

5. Joint according to claim 2, characterized in that the coupling device has a coupling element which can be transferred into either a coupling position or a decoupling position, wherein mechanical, in particular positively locking and/or rotationally conjoint, coupling of a spring of the drive device to the first joint part or to the second joint part is effected by the coupling element in the coupling position, and the mechanical coupling is eliminated in the decoupling position.

6. Joint according to claim 5, characterized in that
a. the coupling element, when in the coupling position, engages into a recess of the first joint part or of the second joint part, and/or in that
b. the coupling element, when in the coupling position, is non-rotatable relative to the recess, into which it engages, of the first joint part or of the second joint part, and/or in that
c. the coupling element is of non-circular, in particular polygonal, form in cross section and, when in the coupling position, engages into a corresponding non-circular, in particular polygonal, recess of the first joint part or of the second joint part, and/or in that
d. the coupling element is in the form of an in particular linearly displaceable slide, and/or in that
e. the coupling element is in the form of a slide which, in order to effect the coupling position, is arranged such that it can be slid, in particular in positively locking fashion, into a recess of the first joint part or of the second joint part, and/or in that
f. the coupling element is in the form of a slide which, in order to effect the decoupling position, can be pulled out of a recess of the first joint part or of the second joint part.

7. Joint according to claim 6, characterized in that the recess is arranged in a joint head or in a joint head receptacle.

8. Joint according to claim 5, characterized in that
a. the coupling element is arranged, in particular in movable fashion, in a joint head or in a joint head receptacle, and/or in that
b. the coupling element forms a joint head, and/or in that
c. the coupling element is arranged on the pivot axis of the joint, and/or in that
d. the coupling element is guided so as to be displaceable along the pivot axis of the joint.

9. Joint according to claim 1, characterized in that
a. the first joint part has a joint head and the second joint part has a joint head receptacle for the joint head, or in that
b. the second joint part has a joint head and the first joint part has a joint head receptacle for the joint head.

10. Joint according to claim 1, characterized in that the activated drive device is supported, on the one hand, on the joint head and, on the other hand, on the joint head receptacle.

11. Joint according to claim 1, characterized in that
a. at least in a particular pivoting position, the first joint part can be detached from the second joint part, in particular exclusively by virtue of the first joint part and second joint part being pulled apart, regardless of whether the drive device is activated or deactivated, and/or in that
b. the actuation part, at least in a particular pivoting position, is detachable from the first joint part, in particular exclusively by virtue of the first joint part and second joint part being pulled apart, regardless of whether the coupling element is situated in the coupling position or in the decoupling position.

12. Joint according to claim 10, characterized in that the joint head receptacle has a radial opening through which the joint head can be removed from or inserted into the joint head receptacle in a radial direction.

13. Joint according to claim 6, characterized in that the receptacle has an additional, in particular radially oriented opening through which the coupling element can be removed from the receptacle in order to permit a detachment of the first joint part from the second joint part even in the coupling position, at least in a particular pivoting position of the actuation part relative to the base part.

14. Joint according to claim 1, characterized in that
a. the activated drive device is supported, on the one hand, on the first joint part and, on the other hand, on the second joint part, and/or in that
b. the activated drive device acts and/or is arranged between the first joint part and the second joint part.

15. Joint according to claim 1, characterized in that the joint is in the form of a hinged joint.

16. Joint according to claim 1, characterized in that
a. the drive device has at least one spring, in particular a spiral spring or helical spring or leg spring, or in that
b. the drive device has at least one spring which is placed under stress during the pivoting of the first joint part relative to the second joint part and which relaxes so as to assist the return pivoting movement.

17. Food comminution device having a joint according to claim 1.

18. Food comminution device according to claim 17, characterized in that
a. the first joint part is part of a base part or is fixed to a base part, and in that
b. the second joint part is part of an actuation part or is fixed to an actuation part, and in that
c. the base part has a cutting part with at least one cutting blade, and in that
d. the base part and the actuation part are articulatedly connected by means of the joint such that, for pushing through foodstuffs to be commintued, the actuation part can be pivoted from a loading position toward the cutting part into a closed position and subsequently from the closed position back into the loading position.

19. Food comminution device according to claim 18, characterized in that the drive device is designed and arranged so as to assist or effect the pivoting movement from the closed position into the loading position and/or is designed and arranged so as to assist or effect the pivoting movement from the loading position into the closed position.

20. Food comminution device according to claim 18, characterized in that the food comminution device is designed to be placed on a worktop for a comminution process, and/or in that the food comminution device has a stand for placing on a worktop.

21. Food comminution device according to claim 18, characterized in that
a. the base part is in the form of a container for the comminuted food items, and/or in that
b. the base part is in the form of a stand for enabling the food comminution device to be placed on a worktop or has a stand for enabling the food comminution device to be placed on a worktop.

22. Kitchen appliance having a food comminution device according to claim 17, wherein the food comminution device is in the form of a cover, and having a container onto which the food comminution device can be mounted—preferably so as to completely cover the container opening—and/or to which the food comminution device can be fixed.

23. Kitchen appliance according to claim 22, characterized in that
a. the container is in the form of a stand for enabling the food comminution device to be placed on a worktop, and/or in that
b. the kitchen appliance is designed to be placed on a worktop for a comminution process.
